(19) United States
(12) Patent Application Publication
(10) Pub. No.: US 2015/0224350 A1
(43) Pub. Date: Aug. 13, 2015

(54) SAFETY HARNESS ANCHORING SYSTEM

(71) Applicant: Michael Harvey, Alameda, CA (US)

(72) Inventor: Michael Harvey, Alameda, CA (US)

(21) Appl. No.: 14/179,531

(22) Filed: Feb. 12, 2014

(51) Int. Cl. A62B 35/00; F16M 13/02

(52) U.S. Cl. CPC A62B 35/0068; F16M 13/022

(57) ABSTRACT

A safety harness anchoring system that securely attaches to an anchor object from one end of a shaft and provides a rotatable connection for a safety harness from an opposite, turntable end of the shaft. The harness straps rotate freely when connected to the turntable and may rotate up to 360 degrees and move laterally. The turntable rotates independently from the rest of the anchoring system through a series of bearings, nuts, and rods that pass through the shaft. A bearing mates with the turntable to facilitate the rotation. This free movement of the safety harness straps prevents binding, twisting, and crimping by the straps. A ring passes through a hole in the turntable, for providing a sufficient attachment surface. A base plate attaches to the opposite end of the shaft and provides a surface for anchoring to an object.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to safety equipment. More particularly, one or more embodiments of the invention relate to an anchor system for a harness.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Construction workers often wear fall protection harnesses when working in trenches. In some cases, these fall protection harnesses comprise self-retracting devices that are attached to anchors. By way of educational background, an aspect of the prior art generally useful to be aware of is that some current anchors can hold only one harness. Furthermore, some current anchoring systems do not allow for much freedom of movement.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary safety harness anchoring system, in accordance with an embodiment of the present invention. FIG. 1A is a diagrammatic side view of the anchoring system. FIG. 1B is a diagrammatic top view of the anchoring system. FIG. 1C is an exploded side view of a top portion of the anchoring system, and FIG. 1D is a partially cut away diagrammatic side view of a bottom portion of the anchoring system.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention provides a safety harness anchoring system. Many embodiments may be used in conjunction with fall protection harness when working in trenches to provide an anchor to which to fasten self-retracting devices on the harnesses. In some embodiments the safety harness anchoring system may be used to attach a cable reel to an anchor object. The anchor object may include, without limitation, a trench, a mountain side, a rock, a barrier, a tree, a building, and a vehicle. In some embodiments, after the safety harness anchoring system joins with the anchor object, a user wearing the safety harness may hook onto the cable reel. Some embodiments may be designed to attach multiple cable reels to the anchoring system.

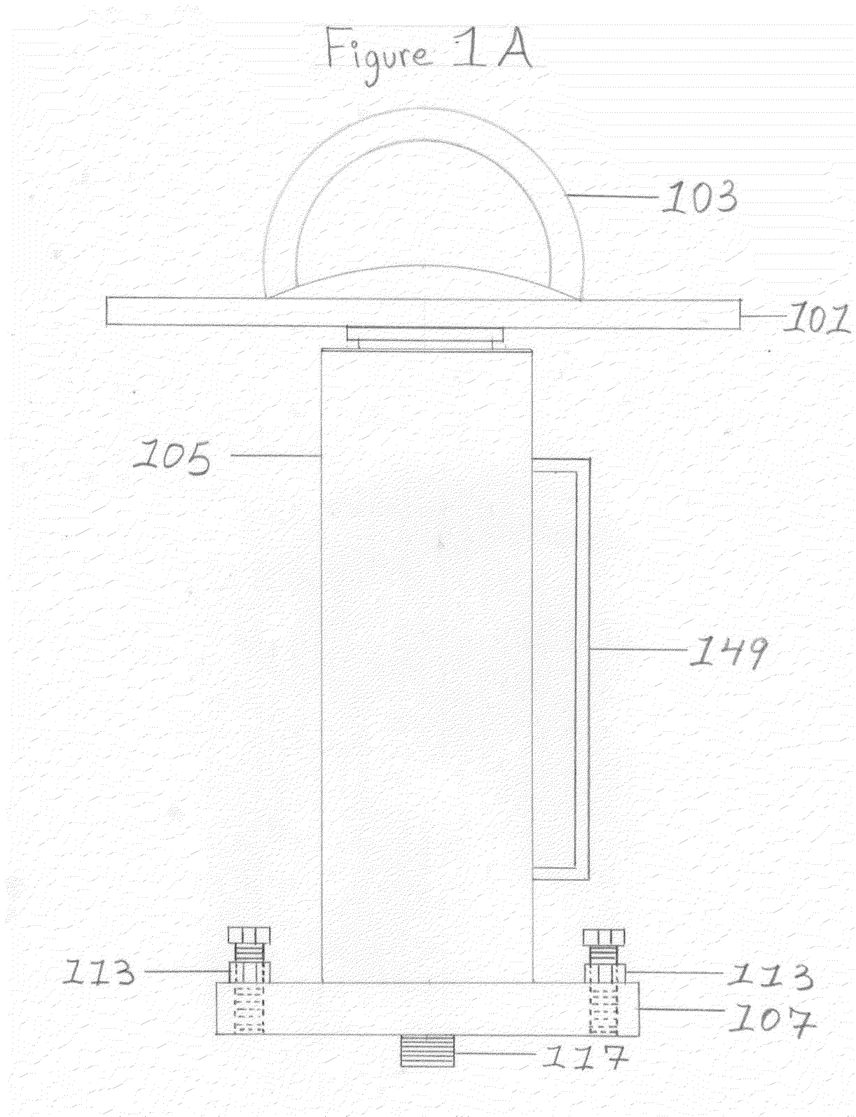

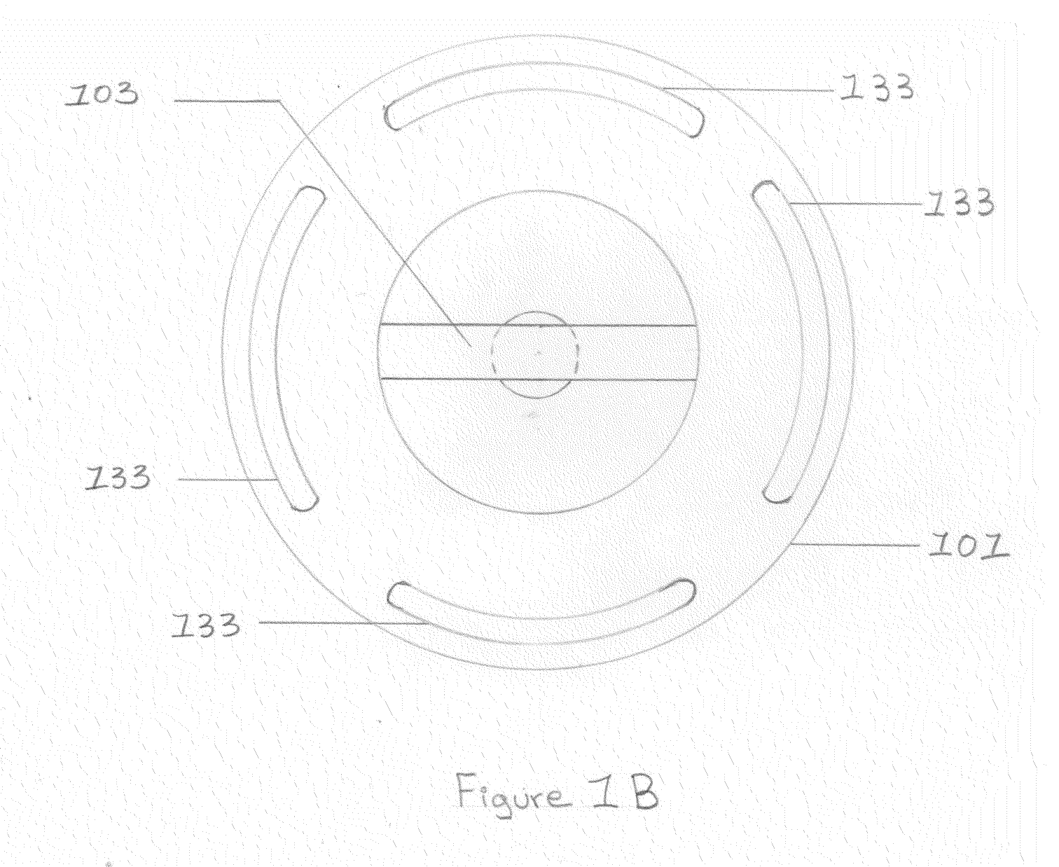

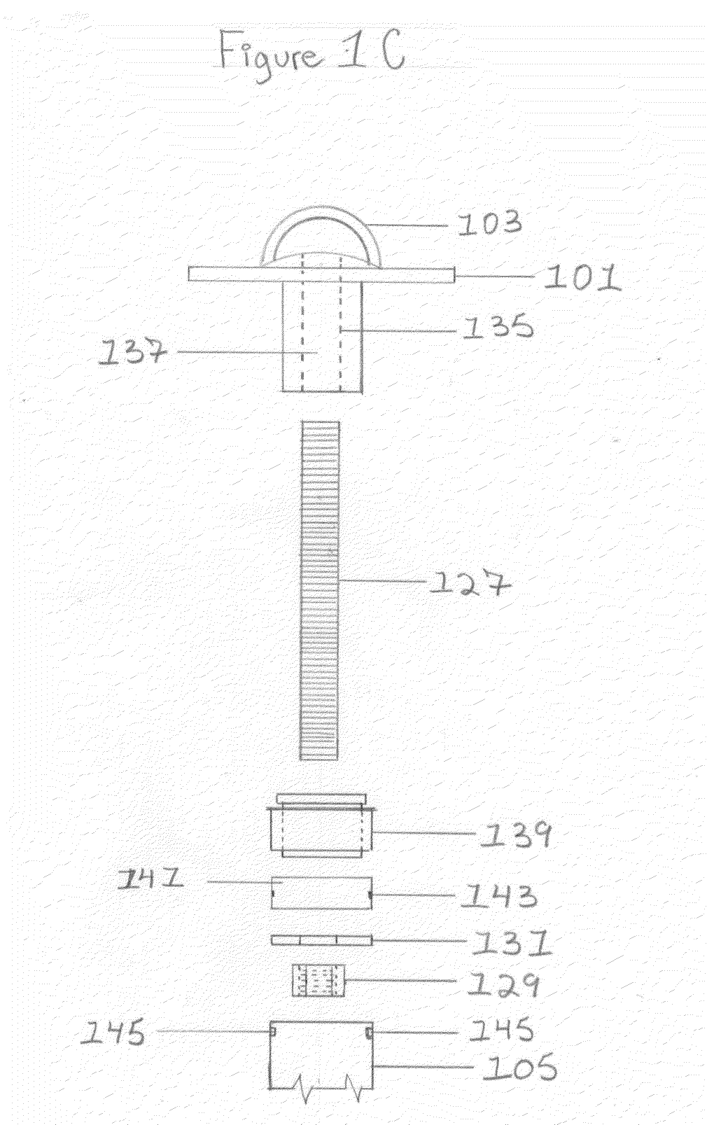

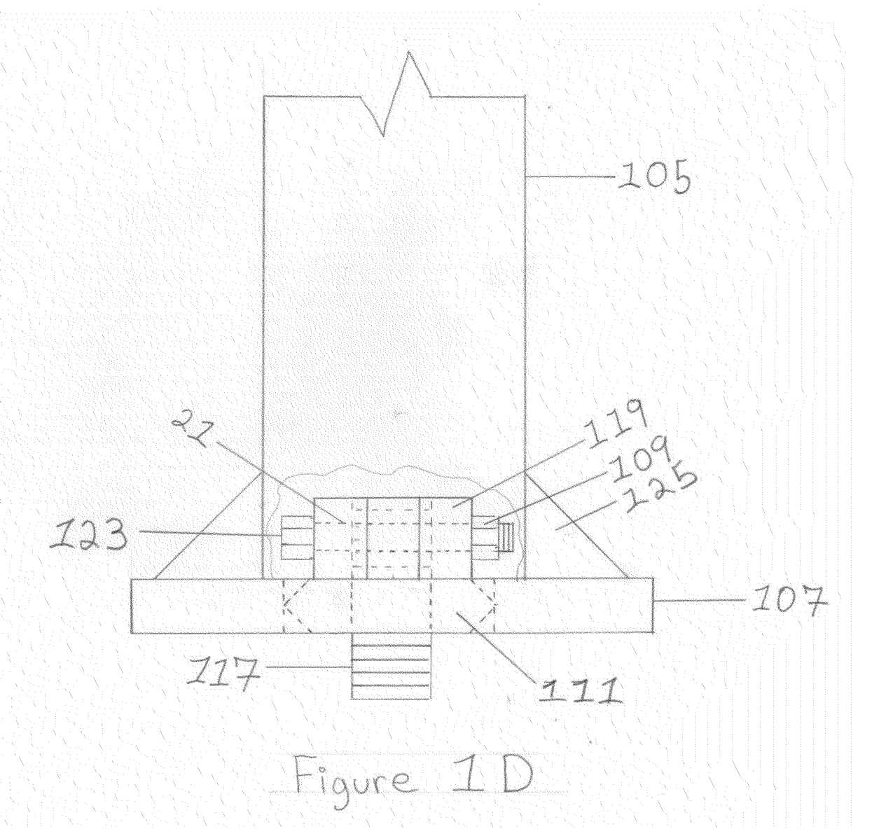

FIGS. 1A through 1D illustrate an exemplary safety harness anchoring system, in accordance with an embodiment of the present invention. FIG. 1A is a diagrammatic side view of the anchoring system. FIG. 1B is a diagrammatic top view of the anchoring system. FIG. 1C is an exploded side view of a top portion of the anchoring system, and FIG. 1D is a partially cut away diagrammatic side view of a bottom portion of the anchoring system. In the present embodiment, the anchoring system comprises a rotating turntable 101 and a ring portion 103 on top of an anchor body 105. In some embodiments, the anchor body 105 may include an anchor end 106 for securing the anchoring system, and a ring end 107 for receiving a harness device. Anchor body 105 comprises a base plate 108 at the bottom. Referring to FIG. 1D, base plate 108 may be attached to anchor body 105 with at least one gusset 109. Alternatively, referring to FIG. 1A, at least one gusset may not be incorporated. However, those skilled in the art, in light of the present teachings, will recognize that the at least one gusset may be efficacious in joining and strengthening the connection between the base plate and the anchor body. Base plate 108 is a nine inch round plate. It is contemplated that in some alternate embodiments base plates of various different sizes and shapes may be used such as, but not limited to, square or rectangular plates.

In the present embodiment, referring to FIG. 1D, base plate 108 comprises a hole in the center into which a threaded insert portion 111 is inserted and secured in place for example, without limitation, by welding, adhesive, bolts, screws, other fasteners, etc. In some alternate embodiments, the hole in the base plate may be threaded without the use of an insert. In the present embodiment, threaded insert portion 111 is inserted so that the lower surface of insert portion 111 is flush with base plate 108. The upper surface of insert 111 may be flush with base plate 108 or may project up from the top of base plate 108. Referring to FIG. 1A, base plate 108 comprises at least one anchor end aperture. In some embodiments, the at least one anchor end aperture may include, without limitation, two ⅝″ threaded anchor end aperture 113 opposite one another and 1½″ inches from the outside edge of base plate 108. At least one anchor fastener 115 may pass through the anchor end aperture 113 to enable the anchoring system to be bolted down during use. In some embodiments, the base plate 108 may be dimensioned and sized as small as ten by ten inches by one inch thick, and may be welded down to a structural “I” beam on a structural building job. The anchor fastener may then be screwed into the base plate and then the harness hooked to the base plate 108. In one embodiment, the at least one anchoring fasteners may include two ¾″ by 2″ threaded bolts that screw into two threaded anchor holes. Those skilled in the art will readily recognize, in light of and in accordance with the teachings of the present invention, that anchoring systems in some alternate embodiments, may be secured in place using various different means. For example, without limitation, the base plate may be secured into place with concrete, the base plate may be welded to a surface, or various different fastening means may be inserted into the base plate such as, but not limited to, stakes, rods, nails, screws, etc. Referring again to FIG. 1D, in the present embodiment, a coil threaded rod 117 approximately 3¼″ long is screwed into at least one anchor end nut 119. In some embodiments, the anchor end nut may include, without limitation, a 1½″ coil thread nut. The rod 117 may rotatably join the anchor end nut so that the top of rod 117 is flush with the anchor end nut 119. A ⅜″ anchor end aperture 121 is made through anchor end nut 119 and a similarly sized and dimensioned rod aperture 118 may be made into the rod 117, into which a rod fastener 123 may be inserted to prevent rotation of the rod 117. The rod fastener 123 may be held in place by at least one lock nut 125. In some embodiments, the lock nut fastener may include, without limitation a ⅜″ by 3½″ long bolt. It is contemplated that the anchor end nut 119 may be held onto the rod using various different means such as, but not limited to, pins, adhesive or set screws in some alternate embodiments. In the present embodiment, threaded rod 117 is screwed into base plate 108 until anchor end nut 119 bottoms out. Anchor end nut 119 is secured to base plate 108 and to rod 117 by welding. In some alternate embodiments, the nut may not be welded to the base plate or thread rod. In the present embodiment, anchor body 105 is a four foot long piece of 4″ schedule 40 pipe that is centered on threaded rod 117 and welded into place. Threaded rod 117 protrudes from the bottom of base plate 108. Those skilled in the art, in light of the present teachings will recognize that threaded rod 117 protrudes from the bottom of base plate 108 to create additional surface area for anchoring into an object. In some alternate embodiments, it is contemplated that the threaded rod may be held in place in the bottom of the anchoring system using various different means such as, but not limited to, cementing the threaded rod into the anchor body or welding the rod directly to the anchor body.

Referring to FIG. 1A, in the present embodiment, a top assembly comprises a 1¼″ coil threaded rod 127 that is approximately 7½″ inches long. A 1¼″ coil thread nut 129 is screwed onto an end of rod 127 so that nut 129 is flush with rod 127. A ⅜″ hole may be drilled through nut 129 and rod 127 into which a ⅜″ by 3½″ bolt and lock nut may be inserted to hold nut 129 in place on rod 127. In some alternate embodiments, the nut may not be bolted to the rod or various different attachment means may be used such as, but not limited to, pins, set screws, adhesives, etc. In the present embodiment, a ⅜″ thick, 4″ diameter round plate 131 is placed on coil threaded rod 127 similarly to a washer until plate 131 bottoms out on nut 129. Nut 129 may be welded to plate 131 and rod 127 if desired. In order to install the top assembly, a centering tool may be used to generally ensure that rod 127 is centered in anchor housing 105. Once, the top assembly is centered, plate 131 is welded to the inside of anchor housing 105. In some alternate embodiments, the coil threaded rod may be secured to the inside of the anchor housing using various different means such as, but not limited to, cementing or bolting the rod in place.

In the present embodiment, referring to FIG. 1B, turntable 101 is a ½″ circular plate with a 12 inch diameter comprising a two inch diameter turntable aperture 102 in the center and at least one slot 133. In some embodiments, the at least one slot may include, without limitation, four ¾″ inch wide by three inch long slots positioned parallel to the outside edge of turntable 101. In some alternate embodiments, the turn table may comprise more or fewer slots of varying shapes and sizes. Referring again to FIG. 1C, in the present embodiment, a piece of schedule 80 pipe 135, approximately three inches long, and drilled out through the center with a 1 5/16″ pipe aperture 137. In some embodiments, the pipe may be inserted into the two inch turntable aperture 102 in the center of turntable 101 so that pipe 135 is flush to the top of turntable 101 and square to turntable 101. Pipe 135 is then welded into place or secured using different means such as, but not limited to, screws, bolts, adhesive, etc. Pipe 135 is pressed onto a bearing 139 until pipe 135 bottoms out. An ER-32T extended inner ring bearing assembly is shown by way of example in the drawing; however, various different types of bearings may be used in some alternate embodiments. In the present embodiment, a shim 141 that is approximately four inches in diameter, one inch wide and ten thousandths of an inch thick comprises at least one shim aperture 143 positioned on the outer perimeter. Each shim aperture may include, without limitation, two 5/16″ holes that are placed about 180 degrees apart from one another. Shim 141 is installed on bearing 139, and shim 141, bearing 139 and pipe and turntable assembly are placed into anchor body 105 over coil threaded rod 127 until bearing 139 bottoms out. At least one anchor body aperture 145 may be located in anchor body 105 that are aligned with each shim aperture 143 in shim 141 into which set screws may be inserted to hold shim 141 in place. In some embodiments, the at least one anchor body aperture may include two 5/16″ holes in the ring end 107.

A portion of coil threaded rod 127 projects through turntable 101 onto which ring portion 103 is screwed until ring portion 103 reaches turntable 101 and is then backed off a quarter turn to generally enable turntable 101 to rotate freely. Ring portion 103 is then welded or otherwise secured to coil threaded rod 127 so that rod 127 is flush to ring portion 103 or with rod 127 projecting slightly above ring portion 103. Referring to FIG. 1A, a handle 149 fabricated out of one inch pipe is welded or otherwise secured to anchor body 105. It is contemplated that some embodiments may comprise handles of various different sizes and shapes or various different means for transport such as, but not limited to, straps or wheels. Some embodiments may comprise multiple handles. Other alternate embodiments may be implemented without handles or means for transport.

In typical use of the present embodiment, base plate 108 is screwed onto the anchor object. In one embodiment, the anchor object may include a trench plate. The trench plate may be placed directly over a trench or to the side of the trench to provide an anchor to which self-retracting cable reels of harness devices may be attached when working near the trench. These harness devices are attached to the at least one slot 133 in turntable 101. Since there are multiple slots 133 in turntable 101, multiple harnesses can be attached to the anchoring system. Some alternate embodiments may be designed to hold more or fewer harnesses. In the present embodiment, turntable 101 rotates independently of ring portion 103 and anchor body 105. The rotation of turntable 101 typically provides more freedom when going from side to side and may lessen or generally prevent binding when working in a trench with multiple workers. Utilizing ring portion 103 on the top of the anchoring system, anchor body 105 and base plate 108 can be lifted and moved to multiple locations. Some alternate embodiments may be implemented without a ring portion.

Alternatively, some embodiments may be implemented to be used in the building of structures rather than when working in trenches. In these embodiments, a base plate as small as ten by ten inches by one inch thick can be welded down to a structural I-beam on a structural building job into which an anchor according to an embodiment of the present invention may be screwed. Harnesses may then be hooked onto the anchor.

Those skilled in the art will readily recognize, in light of and in accordance with the teachings of the present invention, that some alternate embodiments may be implemented with various different specifications and features. For example, without limitation, the anchor system may be made shorter or taller, and many of the components may be implemented in various different sizes. In some alternate embodiments, changes may be made to the turntable or the ring portion, such as, but not limited to, using a turntable with a different shape or using a larger or smaller ring portion. Anchoring systems according to some embodiments of the present invention may be made of various different materials such as, but not limited to, steel or aluminum. Some alternate embodiments may comprise weighted bases for added stability.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a safety harness anchoring system according to the present invention will be apparent to those skilled in the art. The invention has been described above by way of illustration, and the specific embodiments disclosed are not intended to limit the invention to the particular forms disclosed. For example, the particular implementation of the anchor may vary depending upon the particular type of application for which the anchor is to be used. The anchors described in the foregoing were directed to construction implementations; however, similar techniques are to provide anchors for various different types of activities with which harnesses may be used including, without limitation, rock climbing, window washing, the painting of large structures, maintenance work, stunt performances, etc. Non-construction implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An anchoring system comprising:
a base plate, said base plate being configured to engage an anchor object;
an anchor body, said anchor body comprising a ring end, said ring end being configured to support a harness device, said anchor body further comprising an anchor end, said anchor end being disposed to extend from said base plate;
a ring portion, said ring portion being configured to join with said ring end, said ring portion being operable to receive at least one harness device;
a rod, said rod being disposed to position inside said anchor body, said rod comprising a rod aperture; and
a turntable portion, said turntable portion being operable to rotate independently of said anchor body and said ring portion, said turntable portion being disposed to position on said ring end, said turntable portion comprising at least one slot for receiving at least one harness device, said turntable portion further comprising a turntable aperture, said turntable aperture being configured to allow said ring portion to pass through said turntable portion, said turntable portion further comprising a pipe, said pipe being configured to extend from said turntable portion, said pipe comprising a pipe aperture, said pipe aperture being configured to receive said rod, said pipe aperture being further configured to receive at least one bearing, said at least one bearing being operable to rotate said turntable.

2. The anchoring system of claim 1, in which said ring end comprises a shim, said shim being disposed to occupy a space between said at least one bearing and a plate, said plate being disposed to press against a nut, said nut being configured to join with said rod, said shim comprising at least one shim aperture, said shim aperture being configured to align with an exterior anchor body aperture, said anchor body aperture being configured to allow at least one fastener to pass through, said at least one fastener being operable to secure said shim to said anchor body.

3. The anchoring system of claim 2, in which said anchor body comprises at least one handle, said at least one handle being operable to transport said anchoring system.

4. The anchoring system of claim 3, in which said base plate comprises at least one anchor hole, said at least one anchor hole being configured to allow at least one anchor fastener to pass through, said at least one anchor fastener being operable to anchor said base plate to said anchor object, said base plate further comprising an anchor end nut, said anchor end nut comprising an anchor end aperture, said anchor end aperture being configured to allow a rod fastener to pass through, said rod fastener being operable to pass through said anchor end aperture and said rod aperture, said rod fastener being configured to inhibit rotation of said rod, said base plate further comprising at least one lock nut, said at least one lock nut being configured to secure said rod fastener, said base plate further comprising an insert portion, said insert portion being disposed to position parallel to said base plat, said insert portion being operable to allow said rod to pass through.

5. The anchoring system of claim 4, wherein at least one gusset is configured to join said base plate with said anchor body.

6. The anchoring system of claim 5, wherein said turntable portion rotates to minimize binding of said harness device.

7. The anchoring system of claim 6, wherein said anchoring system is operable to join with a trench surface.

8. The anchoring system of claim 7, wherein said ring portion is operable to allow said anchoring system to be lifted and transported.

9. The anchoring system of claim 8, wherein said base plate is sized and dimensioned 10″×10″×1″ thick.

10. The anchoring system of claim 9, wherein said base plate is operable to be welded down to a structural I beam.

11. The anchoring system of claim 10, in which said anchor body comprises an adjustable height.

12. A means for attaching to an anchoring system comprising:
means for positioning a base plate against an anchor object;
means for passing at least one anchor fastener through at least one anchor aperture in said base plate;
means for passing a rod fastener through an anchor end aperture and a rod aperture for inhibiting rotation of a rod.
means for joining a harness device to a ring portion of an anchor body; and
means for rotating said turntable portion independently of an anchor body and a ring portion.

13. An anchoring system comprising:
a base plate, said base plate being configured to engage an anchor object;
an anchor body, said anchor body comprising a ring end, said ring end being configured to support a harness device, said ring end comprising a shim, said shim being disposed to occupy a space between said at least one bearing and a plate, said plate being disposed to press against a nut, said nut being configured to join with said rod, said shim comprising at least one shim aperture, said shim aperture being configured to align with an exterior anchor body aperture, said anchor body aperture being configured to allow at least one fastener to pass through, said at least one fastener being operable to secure said shim to said anchor body, said anchor body further comprising an anchor end, said anchor end being disposed to extend from said base plate, said base plate further comprising at least one anchor hole, said at least one anchor hole being configured to allow at least one anchor fastener to pass through, said at least one anchor fastener being operable to anchor said base plate to said anchor object, said base plate further comprising an anchor end nut, said anchor end nut comprising an anchor end aperture, said anchor end aperture being configured to allow a rod fastener to pass through, said rod fastener being operable to pass through said anchor end aperture and said rod aperture, said rod fastener being configured to inhibit rotation of said rod, said base plate further comprising at least one lock nut, said at least one lock nut being configured to secure said rod fastener, said base plate further comprising an insert portion, said insert portion being disposed to position parallel to said base plat, said insert portion being operable to allow said rod to pass through;
a ring portion, said ring portion being configured to join with said ring end, said ring portion being operable to receive at least one harness device;
a rod, said rod being disposed to position inside said anchor body, said rod comprising a rod aperture;
at least one gusset, said at least one gusset configured to join said base plate with said anchor body; and
a turntable portion, said turntable portion being operable to rotate independently of said anchor body and said ring portion, said turntable portion being disposed to position on said ring end, said turntable portion comprising at least one slot for receiving at least one harness device, said turntable portion further comprising a turntable aperture, said turntable aperture being configured to allow said ring portion to pass through said turntable portion, said turntable portion further comprising a pipe, said pipe being configured to extend from said turntable portion, said pipe comprising a pipe aperture, said pipe aperture being configured to receive said rod, said pipe aperture being further configured to receive at least one bearing, said at least one bearing being operable to rotate said turntable.
